(19) United States
(12) Patent Application Publication
(10) Pub. No.: US 2010/0318203 A1
(43) Pub. Date: Dec. 16, 2010

(54) Audio Recording Apparatus

(76) Inventor: Mitchell T. Brooks, Charlotte, FL (US)

Correspondence Address: HARSHAW RESEARCH, INC., 210 W. TECUMSEH STREET, OTTAWA, KS, 66067, US

(21) Appl. No.: 12/485,245

(22) Filed: Jun. 16, 2009

(51) Int. Cl. G06F 17/00

(52) U.S. Cl. 700/94

(57) ABSTRACT

An audio recording apparatus includes a housing, a processor inside the housing, and a plurality of microphones coupled to the housing, the microphones being in data communication with the processor. A disc burning device and an electronic memory device are in data communication with the processor. A user input is on the housing and in data communication with the processor. The processor includes programming to store audio data obtained by at least one the microphone in the electronic memory device upon receiving a store command from the user input. The processor also includes programming to actuate the disc burning device to record the audio data stored in the electronic memory device on a recordable disc upon receiving a record command from the user input.

### BACKGROUND OF THE INVENTION

This invention relates generally to recording devices and, more particularly, to an audio recording apparatus with features particularly to enable a meeting to be recorded for later playback, transcription, or permanent digital storage.

It is frequently desired that an important meeting be recorded so that it can be played again at a later time. For instance, one or more persons may be unable to attend the meeting in person and have a need to hear it later. Other meetings, such as corporate Board meetings, may need to be later transcribed for permanent record keeping. Still other meetings may include such important information that it needs to reviewed on a regular or frequent basis by certain persons or entire departments.

Various devices have been proposed in the art for recording meetings. Although assumably effective for their intended purposes, the existing devices and proposals provide undesirable audio coverage and quality, do not enable recorded audio to be immediately recorded to a compact disc, or do not provide an interface to a computer or permanent storage device.

Therefore, it would be desirable to have an audio recording device that provides distributed microphones for improved recording quality. Further, it would be desirable to have an audio recording device that includes a compact disc burning device such that recorded audio files may be recorded to a compact disc. In addition, it would be desirable to have an audio recording device that may be interfaced with a computer or permanent digital storage device.

### SUMMARY OF THE INVENTION

An audio recording apparatus according to the present invention includes a housing, a processor inside the housing, and a plurality of microphones coupled to the housing, the microphones being in data communication with the processor. A disc burning device and an electronic memory device are in data communication with the processor. A user input is on the housing and in data communication with the processor. The processor includes programming to store audio data obtained by at least one the microphone in the electronic memory device upon receiving a store command from the user input. The processor also includes programming to actuate the disc burning device to record the audio data stored in the electronic memory device on a recordable disc upon receiving a record command from the user input.

Therefore, a general object of this invention is to provide an audio recording apparatus for digitally recording audio data for later playback, transcription, or storage.

Another object of this invention is to provide an audio recording apparatus, as aforesaid, that can selectively transfer recorded audio data to a compact disc for later playback or storage.

Still another object of this invention is to provide an audio recording apparatus, as aforesaid, that selectively interfaces with a computer or memory storage device for receiving recorded audio data.

Yet another object of this invention is to provide an audio recording apparatus, as aforesaid, that provides excellent audio coverage and quality.

A further object of this invention is to provide an audio recording apparatus, as aforesaid, that is easy to use and cost effective to manufacture.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of an audio recording apparatus according to a preferred embodiment of the present invention with a disc burning device in a closed configuration;

FIG. 2 is another perspective view of the audio recording apparatus as in FIG. 1 with the disc burning device in an open configuration;

FIG. 3a is a rear perspective view of the audio recording apparatus as in FIG. 1;

FIG. 3b is an isolated view on an enlarged scale taken from FIG. 3a;

FIG. 4 is an elevated view of the audio recording apparatus as in FIG. 1 shown connected to an adapter and telephone; and

FIG. 5 is a block diagram of the electronic components of the present invention.

### DESCRIPTION OF THE PREFERRED EMBODIMENT

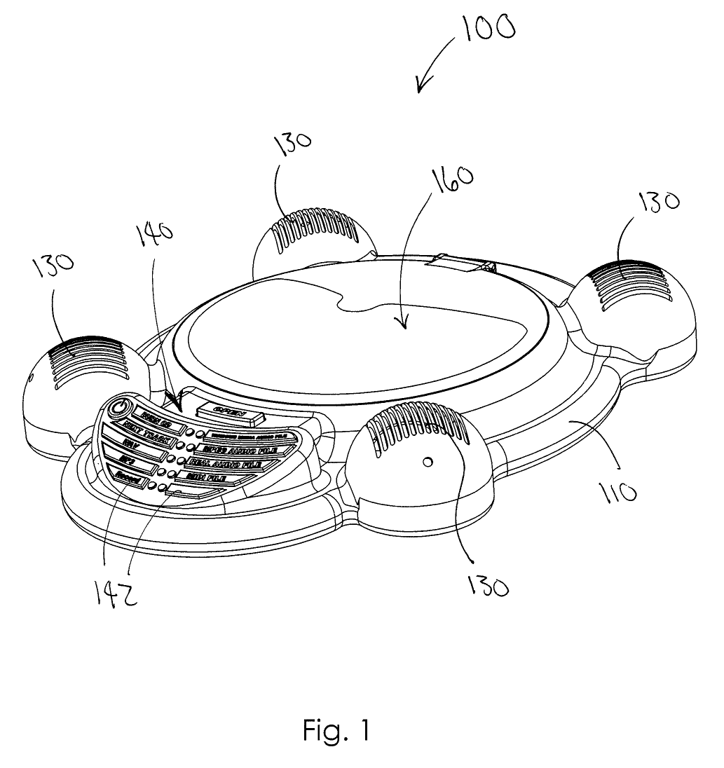

An audio recording apparatus will now be described in detail with reference to FIG. 1 through FIG. 5 of the accompanying drawings. More particularly, an audio recording apparatus 100 of one embodiment includes a housing 110 and a processor 120 inside the housing 110. The processor 120 may be any appropriate electronic processor, as will be apparent to one of ordinary skill in the art.

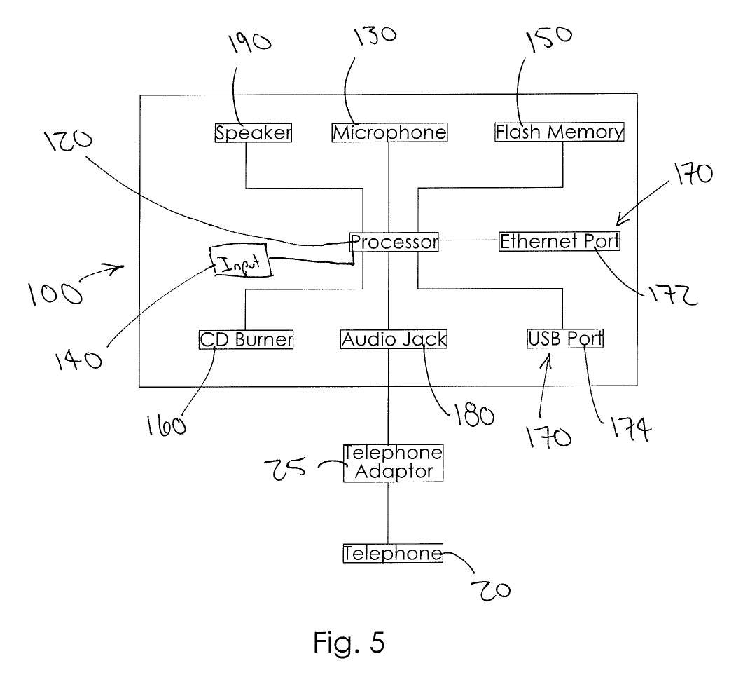

As shown in FIG. 1 and FIG. 5, a plurality of microphones 130 are coupled to the housing 110 and are in data communication with the processor 120. While four microphones 130 are shown in FIG. 1, more or fewer may be used. It may be preferable for each microphone 130 to be directed to a unique location, or in other words for each microphone 130 to be pointed to a different location from one another. This may improve the likelihood that at least one microphone 130 obtains audio data regardless of the specific orientation of the housing 110 relative to the audio data's source.

Still referring to FIG. 1 and FIG. 5, a user input 140, an electronic memory device (sometimes referred to in the industry as “computer memory”) 150, and a disc burning device 160 are in data communication with the processor 120. The user input 140 may be on the housing 110, such as between two microphones 130 (FIG. 1), the electronic memory device 150 may be inside the housing 110, and the disc burning device 160 may be coupled to the housing 110 (FIG. 1). While the memory device 150 is labeled “flash memory” in FIG. 5, it should be appreciated that any appropriate type of volatile or non-volatile memory may be used. Similarly, though the disc burning device 160 is labeled “CD burner” in FIG. 5, the disc burning device 160 may store data to CDs, DVDs, and/or other portable data storage media.

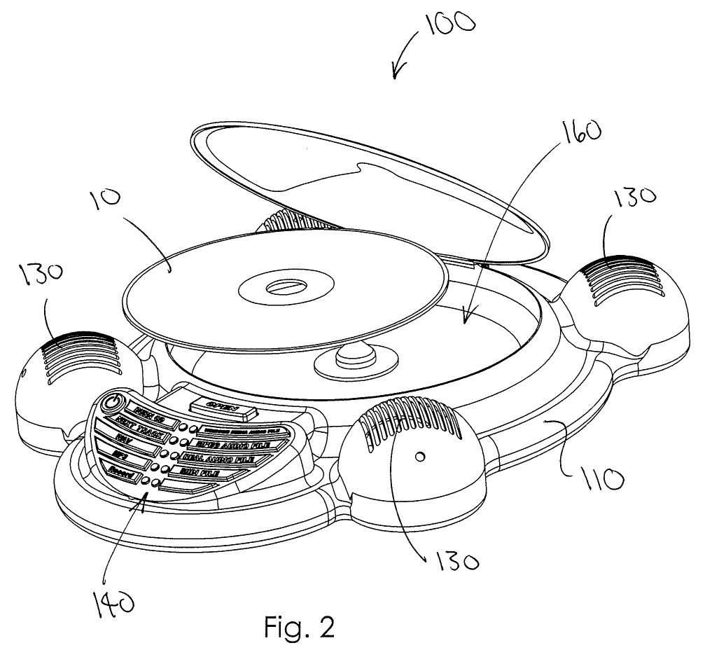

The processor 120 includes programming to store audio data obtained by at least one of the microphones 130 in the memory device 150 upon receiving a store command from the user input 140. Programming is also included in the processor 120 to actuate the disc burning device 160 to record the audio data stored in the memory device 150 on a recordable disc 10 (FIG. 2) upon receiving a record command from the user input 140. The various commands may be entered through the user input 140 using various buttons 142 (FIG. 2), knobs, or other input elements.

In addition to the programming set forth above, the processor 120 may include programming to segment the audio data stored in the memory device 150 using segment indicators (or “track demarcators”) upon receiving a segment command from the user input 140. Programming in the processor 120 may then actuate the disc burning device 160 to incorporate the segment indicators when recording the audio data stored in the memory device 150 to the recordable disc 10.

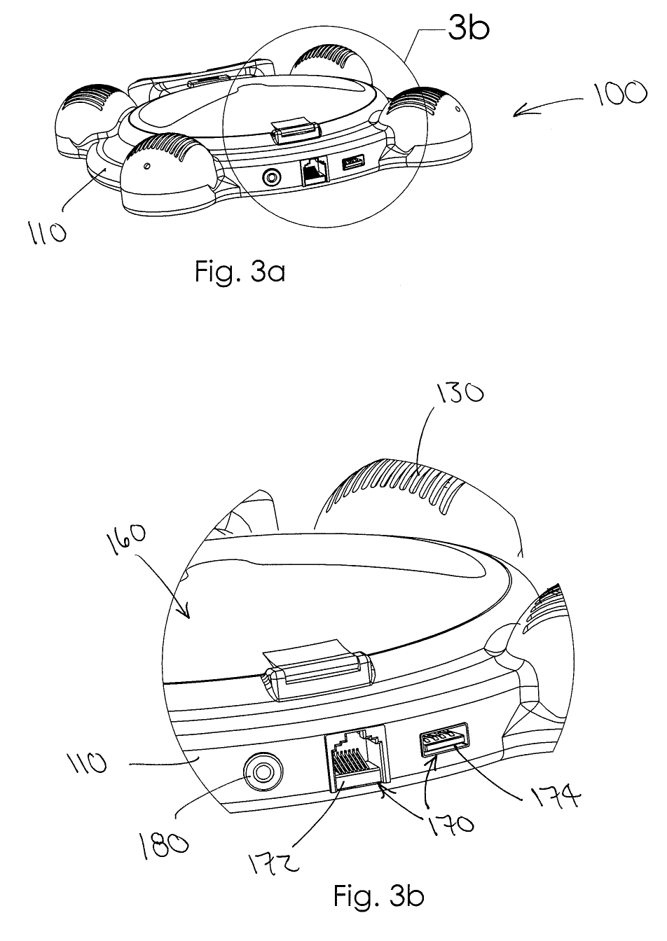

At least one data output port 170 may be in data communication with the processor 120, as shown in FIG. 3b and FIG. 5, and programming in the processor 120 may output audio data stored in the memory device 150 through the data output port 170 upon receiving a data output command from the user input 140. While data output ports 170 are shown to be an ethernet port 172 and a USB port 174 in FIG. 3b and FIG. 5, one of ordinary skill in the art will appreciate that other output ports (whether now existing or later developed) may be used to allow the transfer of audio data.

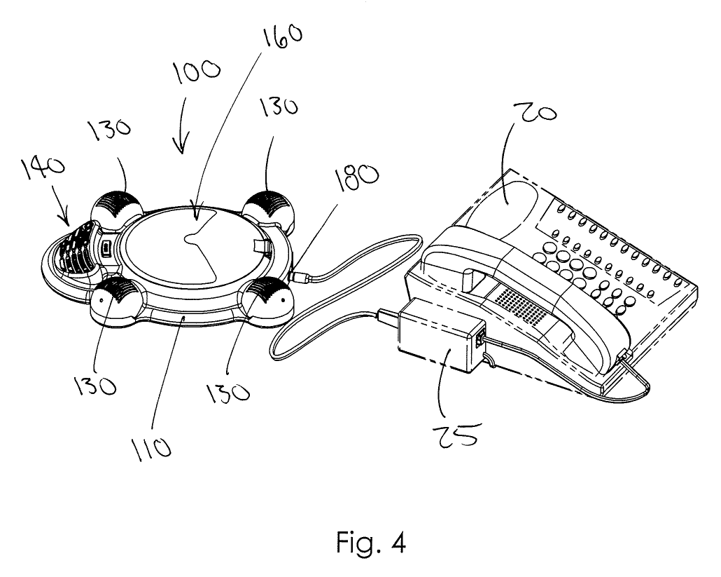

In some embodiments, the audio recording apparatus 100 is configured for use with a telephone 20, as shown in FIG. 4 and FIG. 5. An audio input 180 is in data communication with the processor 120, and the programming in the processor 120 stores audio data in the memory device 150 upon receiving the store command from the user input 140, regardless of whether the audio data is obtained through the microphone(s) 130 or the audio input 180. Further, the programming in the processor 120 actuates the disc burning device 160 to record the audio data stored in the memory device 150 on a recordable disc 10 upon receiving the record command from the user input 140, regardless of whether the audio data is obtained through the microphone(s) 130 or the audio input 180. Moreover, the programming to segment the audio data stored in the memory device 150 may segment the audio data regardless of whether obtained by the microphone(s) 130 or the audio input 180, and the programming to actuate the disc burning device 160 to incorporate the segment indicators may incorporate the segment indicators whether the audio data is obtained by the microphone(s) 130 or the audio input 180.

In these embodiments, a speaker 190 is in data communication with the processor 120, and programming in the processor 120 actuates the speaker 190 to present audio data received through the audio input 180. The audio input 180 may also transfer audio data received through the microphone(s) 130 to the telephone 20 (e.g., through telephone adaptor 25) such that the audio data input through the microphone(s) 130 may be transferred to the telephone 20 for transmission. In other words, the audio input 180 may be a telephone interface port. Also, in these embodiments, the programming to output the audio data through the data output port 170 may output the audio data whether the audio data is obtained by the microphone(s) 130 or the audio input 180.

In use, the microphone(s) 130 obtain audio data, and that audio data is stored in the memory device 150 upon the processor 120 receiving a store command from the user input 140. As set forth above, the configuration of the microphones 130 may allow audio data to be obtained regardless of the specific orientation of the housing 110 relative to the audio data's source. If desired, the user input 140 may be used to input segment commands to the processor 120, and the processor 120 may segment the audio data stored in the memory device 150 in accordance with the segment commands. This may be particularly useful, for example, if the apparatus 100 is being used in a meeting or other environment and the topic of conversation changes; the various topics may be separated in real time by this segmentation. The disc burning device 160 may record the audio data stored in the memory device 150, as well as any segment indicators, upon the processor 120 receiving a record command from the user input 140. The audio data may also be output through the data output port 170 upon the processor 120 receiving a data output command from the user input 140.

If the audio recording apparatus 100 is configured for use with a telephone 20, as discussed above, audio data may be input from the telephone 20 to the audio input 180, and then stored in the memory device 150 upon receiving the store command from the user input 140. The audio data obtained through the audio input 180 may then be treated the same as the audio data obtained through the microphone(s) 130 (e.g., may be segmented, recorded to a disc 10, and/or output through data output port 170). The speaker 190 may present audio data received through the audio input 180 and the audio input 180 may transfer audio data received through the microphone(s) 130 to the telephone 20 (e.g., through the telephone adaptor 25) to allow the audio recording apparatus 100 to serve as a speakerphone device for the telephone 20.

It is understood that while certain forms of this invention have been illustrated and described, it is not limited thereto except insofar as such limitations are included in the following claims and allowable functional equivalents thereof.

1. An audio recording apparatus, comprising:
a housing;
a processor inside said housing;
a plurality of microphones coupled to said housing, said microphones being in data communication with said processor;
a disc burning device in data communication with said processor;
an electronic memory device in data communication with said processor;
a user input on said housing, said user input being in data communication with said processor;
programming in said processor to store audio data obtained by at least one said microphone in said electronic memory device upon receiving a store command from said user input; and
programming in said processor to actuate said disc burning device to record said audio data stored in said electronic memory device on a recordable disc upon receiving a record command from said user input.

2. The audio recording apparatus of claim 1, wherein each said microphone is directed to a unique location, each unique location being different from one another.

3. The audio recording apparatus of claim 1, further comprising:
an audio input in data communication with said processor; and
programming in said processor to store audio data obtained through said audio input in said electronic memory device upon receiving said store command from said user input;
and wherein said programming in said processor to actuate said disc burning device to record said audio data stored in said electronic memory device on a recordable disc upon receiving a record command from said user input is programming in said processor to actuate said disc burning device to record said audio data stored in said electronic memory device whether obtained by at least one said microphone or through said audio input.

4. The audio recording apparatus of claim 3, further comprising:
a speaker in data communication with said processor; and
programming in said processor to actuate said speaker to present audio data received through said audio input.

5. The audio recording apparatus of claim 4, further comprising:
a data output port in data communication with said processor; and
programming in said processor to output audio data, whether obtained by at least one said microphone or through said audio input, through said data output port upon receiving a data output command from said user input.

6. The audio recording apparatus of claim 5, wherein said data output port is one of an ethernet port and a USB port.

7. The audio recording apparatus of claim 6, further comprising:
programming in said processor to segment said audio data stored in said electronic memory device, whether obtained by at least one said microphone or through said audio input, using segment indicators upon receiving a segment command from said user input; and
programming in said processor to actuate said disc burning device to incorporate said segment indicators when recording said audio data stored in said electronic memory device, whether said audio data is obtained by at least one said microphone or through said audio input.

8. The audio recording apparatus of claim 7, wherein each said microphone is directed to a unique location, each unique location being different from one another.

9. The audio recording apparatus of claim 3, further comprising:
programming in said processor to segment said audio data stored in said electronic memory device, whether obtained by at least one said microphone or through said audio input, using segment indicators upon receiving a segment command from said user input; and
programming in said processor to actuate said disc burning device to incorporate said segment indicators when recording said audio data stored in said electronic memory device, whether said audio data is obtained by at least one said microphone or through said audio input.

10. The audio recording apparatus of claim 1, further comprising:
programming in said processor to segment said audio data stored in said electronic memory device using segment indicators upon receiving a segment command from said user input; and
programming in said processor to actuate said disc burning device to incorporate said segment indicators when recording said audio data stored in said electronic memory device.

11. The audio recording apparatus of claim 10, wherein each said microphone is directed to a unique location, each unique location being different from one another.

12. The audio recording apparatus of claim 11, further comprising:
a data output port in data communication with said processor; and
programming in said processor to output audio data through said data output port upon receiving a data output command from said user input.
